(19) United States
(12) Patent Application Publication
(10) Pub. No.: US 2022/0098874 A1
(43) Pub. Date: Mar. 31, 2022

(54) FIRE RESISTANT CLADDING MATERIAL

(71) Applicant: CERAM POLYMERIK PTY LTD, Carrum Downs (AU)

(72) Inventor: Gerard Murray, Carrum Downs (AU)

(21) Appl. No.: 17/309,800

(22) PCT Filed: Dec. 20, 2019
(86) PCT No.: PCT/AU2019/051423

§ 371 Date: Jun. 18, 2021

(30) Foreign Application Priority Data
Dec. 20, 2018 (AU) 2018904868

(51) Int. Cl. E04F 13/08; C04B 35/63; C04B 35/22; C04B 35/626; E04B 1/94; E04F 13/14

(52) U.S. Cl. CPC E04F 13/0866; C04B 35/6303; C04B 35/22; C04B 28/14; E04B 1/942; E04F 13/14; C04B 35/62645

(57) ABSTRACT

The present application relates to fire resistant compositions, particularly fire resistant compositions comprising an inorganic filler. In particular, the disclosure relates to cladding compositions and composite panels comprising the fire resistant cladding compositions. The disclosure also relates to the preparation of such compositions, composite panels and to their use.

The present application is a U.S. national phase application claiming priority to PCT/AU2019/051423, filed Dec. 20, 2019, which claims priority to Australian provisional application number AU2018904868, filed 20 Dec. 2018, which is hereby incorporated by reference in its entirety.

### TECHNICAL FIELD

The present application generally relates to fire resistant compositions including as articles or panels comprising the compositions. In particular, the disclosure relates to cladding compositions and composite panels comprising the fire resistant cladding compositions. The disclosure also relates to the preparation of such compositions, composite panels and to their use.

### BACKGROUND

Aluminium composite panels (ACP) are used in the building industry, often to cover the outside of surface of buildings (façade). ACP are flat panels which typically consist of two thin aluminium sheets bonded to a non-aluminium core. ACP present a significant potential fire risk, and have been implicated in the fires at Grenfell, Lacrosse, the Television Cultural Centre in Beijing and others.

Accordingly, there is a need for improved building panels and compositions, which, for example, could be used in the core of the ACP and demonstrate improved fire performance, or at least a need to provide the public with alternative building panels and compositions.

### SUMMARY

In one aspect, there is provided a cladding composition comprising: (a) an inorganic binder; (b) a silicate mineral; and (c) an inorganic phosphate. The inventors have found that compositions that include a combination of inorganic binder, inorganic phosphate, and silicate mineral can be used to form cladding products and have a performance sufficient to present a useful barrier to propagation of fires through structures containing the composition.

In some embodiments, the composition is substantially free of organic polymer. For example, the composition may comprise less than 5% by weight, less than 4% by weight, less than 2% by weight, less than 1% by weight, less than 0.5% by weight, less than 0.1% by weight, or less than 0.01% by weight organic polymer. In some examples, the organic polymer is selected from the group consisting of plastics, acrylate polymers, polyurethanes, polyethylenes, polyesters, polycarbonates, polyamides, polyethers, polyolefins, and vinyl polymers. In some examples, organic polymers include polyurethane and/or polyethylene. In some embodiments, the organic polymer may be polyethylene or polyurethane, for example. In one particular embodiment, the composition comprises less than 4% by weight of an organic polymer selected from the group consisting of polyethylene and polyurethane.

In some embodiments, the composition further comprises a borate. In some examples, the borate is zinc borate. In some examples, the borate is present in an amount of 0.1% to 10% by weight of the total composition.

In some embodiments, the inorganic phosphate is selected from the group consisting of ammonium phosphate, ammonium polyphosphate, ammonium pyrophosphate, and combinations thereof. In one example, the inorganic phosphate is ammonium polyphosphate. In another example, the inorganic phosphate is present in an amount of 10% to 40% by weight of the total composition.

In some embodiments, the silicate mineral is selected from the group consisting of an alumino-silicate, an alkali alumina-silicate, a magnesium silicate, a calcium silicate, and combinations thereof. In one example, the silicate mineral is wollastonite. In another example, the silicate mineral is present in an amount of 20% to 60% by weight of the total composition.

In some embodiments, the inorganic binder is selected from the group consisting of cement, gypsum, plaster of Paris, and combinations thereof. In one example, the inorganic binder is gypsum (CaSO₄.2H₂O). In another example, the inorganic binder is plaster of Paris (CaSO₄.0.5H₂O). In some examples, the inorganic binder is present in an amount of 10% to 60% by weight of the total composition.

In some embodiments, the composition further comprises a heat expandable solid material. For example, the composition may comprise heat expandable solid materials selected from the group consisting of beneficiated flakes of vermiculite, unexpanded perlite, hydrobiotite, unexpanded foam clay, expandable graphite, water-swelling synthetic tetrasilicic fluorine type mica, and combinations thereof. In one example, the heat expandable solid material is expandable graphite. In some examples, the heat expandable solid material is present in an amount of 0.1% to 10% by weight of the total composition.

In some embodiments, the composition further comprises an additive selected from the group consisting of inorganic fillers, set accelerators, set retarders, plasticizers, foaming agents, anti-burning agents, water reducing agents, glass fibres, water proofing agents, smoke reducers, lubricants and additives that can reduce mildew, flammability, and water absorption. In some embodiments, the composition further comprises a water repellent, such as potassium silicate.

The compositions described herein are suitable for the formation of fire-resistant cladding products. Accordingly, one embodiment the composition is a fire-resistant composition. In some examples the composition has a fire resistance based on AS 1530, for example AS1530.1. In some examples, the composition is non-combustible, for example as defined in AS 1530, for example AS1530.1.

In some embodiments, the composition is in the form of a slurry comprising a solvent. In some embodiments, the solvent is water. In some embodiments, the composition is a dried composition.

In a further aspect, there is provided a fire-performance article comprising the composition as described herein. In some examples, the fire-performance article is a panel or cladding. In some embodiments, the composition forms the core of cladding.

In a further aspect there is provided a composite panel comprising one or more outer sheets defining a core, wherein the core comprises or consists of a cladding composition as described herein. In some embodiments, the composite panel comprises two outer layers and a core, wherein the core comprises the cladding composition as described herein.

### DESCRIPTION OF EMBODIMENTS

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

As used herein, the term “about”, unless stated to the contrary, typically refers to +/−10%, for example +/−5%, of the designated value.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Any embodiment herein shall be taken to apply mutatis mutandis to any other embodiment unless specifically stated otherwise.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

The reference to “substantially free” generally refers to the absence of that compound or component in the composition other than any trace amounts or impurities that may be present, for example this may be an amount by weight % in the total composition of less than about 1%, 0.1%, 0.01%, 0.001%, or 0.0001%. The compositions as described herein may also include, for example, impurities in an amount by weight % in the total composition of less than about 5%, 4%, 3%, 2%, 1%, 0.5%, 0.1%, 0.01%, 0.001%, or 0.0001%. An example is the amount of water that may be present in an organic solvent.

The term “exposure to an elevated temperature experienced under fire conditions” is used herein to refer to severe fire conditions as simulated by heating at a temperature of at least 750° C. for a period of 30 minutes. In one example, the temperature is 750° C. In one example, the temperature is 800° C.

As used herein, the term “fire-resistant” generally means a material that does not melt, ignite, or decompose up to a temperature of 250° C. at ambient atmospheric oxygen levels. “Fire-resistance” can be assessed using techniques known to the person skilled in the art. In a preferred embodiment, “fire-resistant” means “non-combustible” in accordance with AS1530.1.

All details in percentages refer to weight percentage of total dry ingredients in the composition unless otherwise indicated. For the avoidance of doubt, “dry ingredients” include but are not limited to (a) inorganic binder; (b) a silicate mineral; (c) an inorganic phosphate, (d) borate compound and (e) heat expandable solid.

The term “and/or”, e.g., “X and/or Y” shall be understood to mean either “X and Y” or “X or Y” and shall be taken to provide explicit support for both meanings or for either meaning.

In one aspect, there is provided a cladding composition comprising: (a) an inorganic binder; (b) a silicate mineral; and (c) an inorganic phosphate. The inventors have found that compositions that include a combination of inorganic binder, inorganic phosphate, and silicate mineral can be used to form cladding products and have a performance sufficient to present a useful barrier to propagation of fires through structures containing the composition. Without wishing to be bound by theory, it is thought that the composition forms a ceramic on exposure to an elevated temperature experienced under fire conditions.

In one example, the composition is substantially free of organic polymer, such as polyurethane and/or polyethylene. In some embodiments, the composition of the disclosure contains less than 5% by weight based on the total weight of the composition of an organic polymer. For example, the composition may contain less than 4% by weight, less than 3% by weight, less than 2% by weight, less than 1% by weight, less than 0.5% by weight, less than 0.2% by weight, less than 0.1% by weight, less than 0.05% by weight or less than 0.01% by weight based on the total weight of the composition of an organic polymer. In some embodiments, the compositions of the present disclosure do not comprise an organic polymer. In one example, the composition does not comprise polyurethane. In another example, the composition does not comprise polyethylene. The upper limit for the amount of organic polymer in the composition described herein is influenced by the desired properties of the final composition. The present inventors have found that increased amounts of organic polymer can prevent certain fire resistant standards from being achieved, for example AS1530.1. Examples of organic polymers include plastics, acrylate polymers, polyurethanes, polyethylenes, polyesters, polycarbonates, polyamides, polyethers, polyolefins, and vinyl polymers. In some examples, organic polymers include polyurethane and/or polyethylene.

The compositions of the disclosure contain an inorganic binder. As used herein, an inorganic binder is an inorganic material that can be used to bind together the remaining components of the composition (for example, the inorganic binder can be used to bind together the components of the ceram mixture which is defined below). Examples of inorganic binders include, but are not limited to cement, lime, gypsum and plaster of Paris. In preferred embodiments, the inorganic binder is gypsum or plaster of Paris. In one example, the inorganic binder is plaster of Paris. In one example, the inorganic binder is gypsum. Such inorganic binders are commercially available.

In some embodiments, the composition described herein contains the inorganic binder in an amount of between 10% to 80% by weight of the total composition. The upper limit for the amount of inorganic binder in the cladding composition tend to be influenced by the desired properties of the final composition. If the amount of the inorganic binder exceeds about 80% by weight of the total composition, it is unlikely that a cohesive, non-collapsing residue will be formed during a fire event. In some embodiments, the inorganic binder is present in an amount of 20% to 70% by weight of the total composition, an amount of 20% to 60% by weight of the total composition, an amount of 20% to 50% by weight of the total composition or an amount of 20% to 40% by weight of the total composition. In one example, the inorganic binder is present in an amount of 20% to 30% by weight of the total composition. In one example, the inorganic binder is present in an amount of 25% to 30% by weight of the total composition.

As the person skilled in the art would be aware, gypsum comprises calcium sulphate dihydrate (CaSO₄.2H₂O) and plaster of Paris comprises calcium sulphate hemihydrate (CaSO₄.0.5H₂O). Plaster of Paris can be produced by calcining calcium sulphate dihydrate to partially remove water. Gypsum and/or plaster of Paris offer significant advantages in the compositions described herein and are the preferred inorganic binder. Without wishing to be bound by theory, it is thought that gypsum and plaster of Paris are good fire protection building materials as a result of the stored water. When exposed to relatively high temperatures, such as those produced by high temperature flames or gases, the water vaporizes, which may help to retard heat transmission and/or slow the spread of fire. Accordingly in some embodiments, the composition comprises from 10% to 40%, 15% to 35%, 20% to 30% or 25% to 30% by weight plaster of Paris based on the total weight of the composition. Accordingly in other embodiments, the composition comprises from 10% to 40%, 15% to 35%, 20% to 30% or 25% to 30% by weight gypsum based on the total weight of the composition. In some embodiments, the inorganic binder is plaster of Paris and is present in an amount between 20% and 30% by weight based on the total weight of the composition.

The compositions described herein contain a silicate mineral. Silicate minerals are rock forming minerals with predominately silicate anions. Suitable silicate minerals, include but are not limited to, aluminosilicates (e.g. kaolinite, montmorillonite, pyrophillite—commonly known as clays), alkali aluminosilicates (e.g. mica, felspar, spodumene, petalite), magnesium silicates (e.g. talc) and calcium silicates (e.g. wollastonite). Mixtures of two or more different silicate minerals may be used in the compositions of the present disclosure. Such silicate minerals are commercially available. While silicon dioxide (silica) is often considered a silicate mineral, it is not a silicate mineral in the context of the present disclosure.

Most silicate minerals consist of particles of high aspect ratio. In some embodiments, a high aspect ratio is preferred as the silicate mineral is thought to provide an interlocking skeleton to the ceramic structure formed by the ceram mixture when exposed to fire conditions thereby improving the strength and reducing the shrinkage of the ceramic formed.

In some embodiments, it is also important to select a silicate mineral filler that is sufficiently refractory in the range of temperatures the composition of the disclosure is expected to perform as a fire barrier so that it does not soften too much and cause the structure to collapse. While providing a skeleton to the ceramic formed, most of the silicate mineral particles interact with other components such as the inorganic phosphate to form a fine dispersion of transient liquid located at the edges of the silicate mineral particles which facilitate sintering and thereby strengthening the resulting ceramic.

The silicate mineral may be processed prior to inclusion in the compositions described herein. For example, the silicate mineral may be surface treated with a silane coupling agent in order to enhance its compatibility with other materials present in the compositions of the present disclosure.

In some embodiments, the compositions of the present application comprise a silicate mineral in an amount of greater than 3% by weight based on the total weight of the total composition. In some examples, the compositions of the present application comprise a silicate mineral in an amount of from 10 to 70% by weight based on the total weight of the total composition. In some examples, the silicate mineral is present in an amount of 20 to 60% by weight of the total composition, from 30 to 50% by weight based on the total weight of the dried composition, from 35 to 45% by weight based on the total weight of the dried composition or from 40 to 43% by weight based on the total weight of the dried composition. Where two or more silicate minerals are present in the composition, the total amount of silicate mineral in the composition falls within these ranges.

In some embodiments, the silicate mineral is wollastonite. Wollastonite is composed of calcium, silicon and oxygen (having the chemical formula CaSiO₃) but may also contain some iron, magnesium, manganese, aluminium, potassium, sodium, or strontium ions substituting for calcium in the mineral structure. On crushing, wollastonite typically forms lath- or needle-shaped (acicular) particles. The particles can have an aspect ratio of between about 3:1 to about 20:1. In some embodiments, wollastonite articles with higher aspect ratios are preferred as they provide an interlocking skeleton to the ceramic structure formed thereby improving the strength and reducing the shrinkage of the ceramic formed. Advantageously, the crystal structure and physical properties of wollastonite are stable to about 1,120° C., making wollastonite suitable for use in fire-performance articles. In some examples, the silicate mineral is wollastonite and is present in an amount between 20 to 60% by weight, 30 to 50% by weight, 35 to 45% by weight or 40 to 43% by weight based on the total weight of the dried composition.

In some embodiments, the composition may optionally comprise an inorganic filler. The inorganic filler is in addition to the silicate mineral and inorganic binder. For example, the composition may comprise an inorganic filler which is a metal hydroxide, metal oxide and/or metal carbonate. Examples of metal ions include, but are not limited to, calcium, aluminium, magnesium, barium, caesium, cobalt, iron, lead, manganese, nickel, rubidium, strontium and zinc. The inorganic fillers may be selected from at least one of hydroxides, oxides and carbonates of at least one of aluminium, barium, calcium and magnesium, for example the inorganic filler may be selected from the group consisting of oxides, hydroxides and carbonates of aluminium, calcium and magnesium. In some embodiments, the inorganic filler is alumina trihydrate, magnesium carbonate and/or calcium carbonate. In another embodiment, the composition does not comprise an inorganic filler which is a metal hydroxide, metal oxide and/or metal carbonate. In some embodiments, the composition does not comprise an inorganic filler which is a metal hydroxide, such as aluminium hydroxide and/or magnesium hydroxide. Other examples of inorganic fillers include carbon fibres and inorganic fibres such as glass, glass-ceramics, mineral fibres, slags, carbon, boron or metal fibres. The inorganic fillers may include glass, glass ceramics and mineral fibres. The fibres can have a length of 3 to 4 mm and a diameter of 5 to 50 μm. The inorganic filler may be present in an amount of up to 30%, or up to about 25%, or up to about 20%, or up to about 15%, or up to about 10%, or up to about 5%, or up to about 3% by weight of the total composition. In one example, the amount of the inorganic filler is in the range of from 3% to 20% by weight of the total composition.

The composition of the present disclosure comprises at least one inorganic phosphate compound. One or more advantages may be provided by inorganic phosphates that form a liquid phase at relatively low temperatures under fire conditions. Accordingly, the composition may comprise an inorganic phosphate compound that forms a liquid phase at a temperature of less than 800° C., for example no more than 500° C., or no more than 300° C. In these embodiments, inorganic phosphate compounds that have relatively high melting points (such as boron phosphate which has a melting point >1200° C.) and do not form a liquid phase at a temperature of no more than 800° C. may be present in the composition but do not form part of the inorganic phosphate component of the composition. Without wishing to be bound by theory, it is thought that that on exposure to an elevated temperature as experienced under fire conditions the inorganic phosphate component in the composition forms a transient liquid phase. Its interaction with other components of the composition results in formation of solid phases and transformation of the composition into a solid ceramic at high temperature. It is thought that the inorganic phosphate compounds that have relatively high melting points generally do not contribute to the transient liquid phase which is reactive with the silicate mineral.

Inorganic phosphates, and in particular systems based on ammonium polyphosphate, have the significant advantage of maintaining the integrity of the composition in combination with the other components of the composition of the present disclosure. It is thought that the inorganic phosphate component also improves the strength of the resulting ceramic by providing a degree of adhesion between particulates of inorganic materials (particularly the silicate mineral filler) on formation of a ceramic.

In some embodiments, the inorganic phosphate is present in an amount of from 5 to 40% by weight of the total composition. The amount of the inorganic phosphate may be in the range of from 10 to 30% by weight of the total composition, for example from 15 to 25% by weight based on the total weight of the composition. Where there is more than one inorganic phosphate, the total amount of inorganic phosphates is in the specified range. In some embodiments, the amount of inorganic phosphates that form a liquid phase at a temperature of less than 800° C. is in the specified range. In some embodiments, the amount of inorganic phosphates that form a liquid phase at a temperature of less than 500° C. is in the specified range. In some embodiments, the amount of inorganic phosphates that form a liquid phase at a temperature of less than 300° C. is in the specified range.

Examples of inorganic phosphates that are suitable for use in compositions of the present disclosure include ammonium phosphate, ammonium polyphosphate, ammonium pyrophosphate, calcium dihydrogen phosphate, monopotassium phosphate, dipotassium phosphate, disodium pyrophosphate and sodium hexametaphosphate. In some embodiments, the inorganic phosphate is selected from the group consisting of ammonium phosphate, ammonium polyphosphate or ammonium pyrophosphate or a combination thereof. These inorganic phosphates decompose and form a liquid phase (containing phosphorous pentoxide) at temperatures in the range of approximately 200 to 800° C. Suitable inorganic phosphates are commercially available.

Ammonium polyphosphate offers further advantages in the compositions of the disclosure. In one embodiment the inorganic phosphate is ammonium polyphosphate. Ammonium polyphosphate is an inorganic salt of polyphosphoric acid and ammonia typically having the chemical formula [NH₄PO₃]ₙ(OH) wherein n is an integer. The polyphosphate chain can be branched or linear. Ammonium polyphosphate can be obtained commercially, for example under the tradename Exolit® (Clariant). In some embodiments, the inorganic phosphate is ammonium polyphosphate and is present in an amount between about 5 to 40% by weight, about 10 to 30% by weight, about 15 to 25% by weight, or 19 to 22% by weight based on the total weight of the composition.

The compositions of the present disclosure may optionally comprise a borate. The borate may be any borate compound that decomposes to produce boric oxide under fire conditions. Suitable borates include, but are not limited to, zinc borate, borax (sodium borate) and ammonium borate. In some embodiments, the borate is present in an amount of 0.1% to 10% by weight, 1% to 8% by weight, 2% to 6% by weight, or 3% to 5% by weight of the total composition.

In some embodiments, the borate compound is zinc borate. Zinc borate is known to decompose to provide boric oxide, which can act as a fluxing oxide as described below. In some embodiments, the compositions comprise up to about 10% of zinc borate by weight of the total composition, for example up to about 9% by weight, up to about 8% by weight. up to about 7% by weight, up to about 6% by weight, up to about 5% by weight, up to about 4% by weight, up to about 3% by weight or up to about 2% by weight. In some embodiments, at least 1% by weight of zinc borate is present, and more preferably at least 2% by weight zinc borate is present. In some embodiments, the borate compound is zinc borate and is present in an amount of 0.1% to 10% by weight, 1% to 8% by weight, 2% to 6% by weight, or 3% to 5% by weight of the total composition.

In some embodiments, the composition further comprises a heat expandable solid material. Suitable heat expandable solid materials include, but are not limited to, beneficiated flakes of vermiculite, unexpanded perlite, hydrobiotite, unexpanded foam clay, expandable graphite and water-swelling synthetic tetrasilicic fluorine type mica. In some embodiments, the heat expandable solid material comprises expandable graphite, such as Grafguard®. In some embodiments, the heat expandable solid material is present in an amount of 0.1% to 10% by weight of the total composition. In one example, the heat expandable solid material is present in an amount of 2% to 6% by weight of the total composition. In some embodiments, the heat expandable solid material is lightweight and can be added to the composition described herein used to reduce the weight of the final composite panel or article. In one example, the a heat expandable solid material is expandable graphite (e.g. Grafguard®) and is present in an amount of between 0.1% to 10% by weight, 1% to 8% by weight, 2% to 6% by weight, or 3% to 5% by weight of the total composition.

Together, the inorganic phosphate, silicate mineral (and optionally the borate and heat expandable solid material) form a ceram mixture. In some embodiments, the ceram mixture comprises or consists of the inorganic phosphate and silicate mineral. In some embodiments, the ceram mixture comprises or consists of the inorganic phosphate, silicate mineral and borate. In some embodiments, the ceram mixture comprises or consists of the inorganic phosphate, silicate mineral, borate and heat expandable solid material. The ceram mixture is a ceramifiable composition which on exposure to an elevated temperature experienced under fire conditions forms a ceramic.

Under fire conditions the inorganic phosphate and borate (when present) produce phosphorous oxide and boric oxide respectively. These oxides act as fluxes which melt at relatively low temperatures and react with the silicate mineral component. This reaction results in a liquid phase which can effectively bond the silicate mineral and other optional refractory components formed from metal oxides, hydroxides or carbonates, to form a coherent ceramic product when exposed to elevated temperatures. As a result this product exhibits desirable physical and mechanical properties. Advantageously, in some embodiments, the compositions are non-collapsing, i.e. they remain rigid and do not undergo an excessive amount of heat induced deformation and/or flow.

In some embodiments, the cladding composition comprises or consists of: (a) an inorganic binder; (b) a silicate mineral; (c) an inorganic phosphate, (d) a borate compound; (e) a heat expandable solid; and (0 optional additives. In one example, the cladding composition comprises or consists of: (a) between 20% to 40% by weight of an inorganic binder; (b) between 30% to 50% by weight of a silicate mineral; (c) between 10% to 30% by weight of an inorganic phosphate, (d) between 0.1% to 10% by weight of a borate compound; (e) between 0.1% to 10% by weight of a heat expandable solid; and (f) 0% to 10% by weight additives. In some embodiments, the cladding composition comprises or consists of: (a) plaster of Paris and/or gypsum; (b) wollastonite; (c) ammonium polyphosphate, (d) a zinc borate; and (e) expandable graphite. In one example, the cladding composition comprises or consists of: (a) between 20% to 40% by weight of plaster of Paris and/or gypsum; (b) between 30% to 50% by weight of wollastonite; (c) between 10% to 30% by weight of ammonium polyphosphate, (d) between 0.1% to 10% by weight of zinc borate; (e) between 0.1% to 10% by weight of expandable graphite; and (f) 0% to 10% by weight additives.

The composition may optionally contain a range of additives which do not interfere with the interaction of the components in forming a ceramic/fire-resistance of the composition. Suitable additives include, but are not limited to, other inorganic fillers (for example lightweight fillers), set accelerators (such as ground gypsum, potassium sulphate), set retarders (such as diethylene triamine tetra acetic acid), plasticizers, foaming agents (such as lauryl alcohol ether sulphates), anti-burning agents (such as boric acid), water reducing agents (such as condensed naphthalene sulphonates), glass fibres for improved physical properties and fire resistance, other agents to improve reaction to fire properties, water proofing agents (such as wax or silicones), smoke reducers, lubricants and various additives that can reduce mildew, flammability, and water absorption or other agents. For example, in some embodiments the composition may further comprise an additive that reduces water absorption such as H-siloxane (polymethylhydrosiloxanes), alkali alkyl siliconates (e.g. potassium methylsiliconate), silicates (e.g. potassium silicate) and the like. In some embodiments, the additive is chopped glass or a glass frit.

In some embodiments, the additive is a smoke reducer. Smoke reducers are used for binding soot, thus reducing the amount of toxic smoke particles in the case of fire. Suitable smoke reducers include, but are not limited to, smoke reducers made of zinc chlorate or ferrocenes, and may for example be in the form of a powder. In some examples, the composition comprises up to 3% by weight, for example 0.1 to 1% by weight, of smoke reducers.

In some embodiments, the additive is a lubricant. Examples of lubricants that may be used are: fatty acids, fluoropolymers, metallic fatty acids, paraffin wax, polysiloxanes, polyalkylsiloxanes and polyorganosiloxanes with functional groups. Commercial lubricants that may be used are vinyl functionalized polysiloxanes like Tergomer® V-Si 4042 from Evonik, stearic fatty acids like Pristerene™ 4913 from Croda, polydimethylsiloxane AK150 from Wacker, fluoropolymer Dynamar™ FX 5912 X from 3M. The amount of lubricant may range from about 1% to about 5% by weight, or about 2% to about 5% by weight, or about 2% to about 4% by weight, based on the weight of the total composition.

In some embodiments, the additive is a lightweight filler such as foam glass. Foam glass is a lightweight material manufactured by heating a mixture of crushed or granulated glass and a blowing agent such as carbon or limestone. Foam glass can be manufactured fully out of waste glass, with only a minimum of additives. Foam glass is light weight and high strength and can provide thermal and acoustic insulating properties. Accordingly, the use of foam glass as a lightweight additive can be useful in the compositions described herein.

As would be understood by the person skilled in the art, the amount of additive included in the composition depends on the additive and the chemical and physical properties provided by the additive. In some embodiments, the composition comprises up to 10% by weight, for example 0.1% to about 10% by weight, or about 0.1% to about 5% by weight, or about 0.1% to about 3% by weight, or about 0.1% to about 3% by weight of additive based on the weight of the total composition. In other embodiments, the composition comprises between 1% to about 10% by weight, or about 2% to about 5% by weight, or about 2% to about 4% by weight, or about 2% to about 3% by weight of additive based on the weight of the total composition.

In some embodiments, the cladding composition is a fire resistant composition. For example, in some embodiments the composition does not melt, ignite, or decompose up to a temperature of 250° C. at ambient atmospheric oxygen levels. In some embodiments, the composition does not melt, ignite, or decompose up to a temperature of 350° C., 450° C., 550° C., 650° C. or 750° C. at ambient atmospheric oxygen levels. In some embodiments, the cladding composition is a non-combustible composition. In one example, the cladding composition is meets the requirements of AS 1530.1. In one example, the cladding composition is meets the requirements of ISO 1182.

The ability of the cladding composition to resist fire and the associated extreme heat may be evaluated by carrying out generally-accepted tests. Examples of such tests are routinely used in the construction industry, such as AS1530.1 standard combustibility test. In some embodiments, the composition is deemed non-combustible under AS 1530.1. AS 1530.1 is a small-scale material fire test involving immersing a test sample of the material (e.g. 50 mm) in a furnace held at 750° C. The test sample is cut into a 50-mm×45-mm diameter cylinder and 5 test samples are tested. Under AS 1530.1, a material is deemed combustible if: (i) the material flames for a period of 5 seconds or longer at any time during the test; (ii) the mean furnace thermocouple temperature rise exceeds 50° C.; and (iii) the mean specimen surface thermocouple temperature rise, as determined in accordance with exceeds 50° C. All five samples must be deemed non-combustible to pass the test.

The cladding composition described herein can be used for fire barrier applications. Examples of such applications include composite panels and barrier coatings on various applications. Accordingly, in a further aspect, there is also provided a fire-performance article comprising the composition as described herein. In some examples, the fire-performance article is in the form of a panel, cladding, screen, or coated substrate. In some examples, the fire-performance article is cladding and the composition forms the core of cladding. For example, the cladding may be in the form of a coated substrate, wherein the substrate is provided by an outer layer as described below comprising a coating thereon of the composition as described herein.

In another aspect, there is a provided a composite panel comprising two outer layers that together define an inner core. The two outer layers may be substantially opposing (e.g. parallel) each other such that the core is defined therebetween. In some embodiments, the core comprises the cladding composition as described herein. In another embodiment, the core consists of the cladding composition as described herein. The outer layers have an inner and outer surface. The inner surface is in contact with the core composition.

The outer layers of the composite panel can be in the form of a foil, film, sheet, strip or plate shaped material. The outer layers can be manufactured from any suitable material. As would be understood by the person skilled in the art, a suitable material would preferably be non-combustible and meet the required standard (for example, AS1530.1). In some embodiments, the material may be metallic, for example a metal or metal alloy. The metal may be any metal used in the art. Suitable metals include, but are not limited to, iron, steel, zinc, tin, zinc coated iron, copper, bronze, aluminium and aluminium alloy. In one example, the outer layers of the composite panel are manufactured from aluminium or an aluminium alloy. Although it is possible that the two outer layers are manufactured from different materials, in some embodiments, the two outer layers are manufactured from the same metal.

In some embodiments, the two outer layers may be joined to the core by an adhesive or bonding agent. As would be understood by the person skilled in the art, the adhesive or bonding agent would preferably be non-combustible and meet the required standard. In some embodiments, the adhesive or bonding agent is sodium silicate or potassium silicate. In one embodiment, the inner surface of the outer layer has a coating of sodium silicate, which acts as an adhesive between the inner surface of the outer layer and the cladding composition. Sodium silicate, commonly known as “water glass” is a versatile, inorganic chemical made by combining various ratios of sand and soda ash (Na₂CO₃). The ratios of sand and soda ash can be varied to vary the chemical and physical properties. In one example, a sodium silicate solution (e.g., 35% Na₂SiO₃ solution in water) can be applied to the inner surface by a brush or other application device. In some examples, the inner surface of the outer layer can be scratched or roughened, and then cleaned with a solvent (e.g., isopropanol) prior to applying the adhesive or binding agent (e.g. sodium silicate) to allow for better adhesion. The outer layers are allowed to dry (although there needs to be some residual water in the sodium silicate to enable adhesion) before being contacted with the cladding composition. The cladding composition can be pre-formed (e.g. as a panel or sheet) of formed on the outer layer. If under the given conditions, the cladding composition exhibits adequate bonding properties, then it may be bonded directly to the outer layers. For example, the two outer layers may be joined to the core by components of the cladding composition.

The outer layers can a have thickness of between 0.1 and 5 mm. In some embodiments, the thickness of the outer layers is between 0.1 and 3 mm, for example between 0.3 and 2 mm, or between 0.5 and 1.25 mm. In some embodiments, the thickness of the outer layers is 0.5 and 1.25 mm for aluminium or aluminium alloy outer layers. The thickness of the two outer layers may be the same or different.

In some embodiments, the composite panel further comprises one or more liners. In some embodiments, a first and a second liner sandwich the core. In yet other embodiments, a liner is embedded within the core. In some embodiments, the liner is a glass webbing or fibre glass webbing. The liner can provide additional strength to the core and/or can assist in the manufacture of the composite panel core.

In some embodiments the composite panel, has a total thickness (including the thickness of the outer layers and the core) of between 2 mm and 8 mm, for example 3 mm to 6 mm. At this thickness, the composite panels are relatively lightweight and thus are easy to handle. This provides an advantage in view of the assembling process on building sites, especially in the case of an application as facade panels.

In some embodiments, the composite panel further comprises a printed layer coating on an outer surface of at least one of the two outer layers. A printed layer coating can be customised based on the needs of the end user. In some embodiments, the outer surface of at least one of the two outer layers is spray-painted or coated with a sticky foil.

In some embodiments, the composite panel further comprises a protective layer applied on the outer surface of one or two of the outer layers. Any suitable protective layer may be used. The protective layer can protect the composite panel from environment factors, such as ultraviolet radiation or extreme weather conditions. In some embodiments, the protective layer can be permanently fixed to the composite panel. In alternative embodiments, the protective layer can be temporarily attached to the composite panel to provide protection as long as the panels are not mounted.

The composite panels are suitable for use, for example, as building materials, facade panels, cladding on building constructions, dividing walls in buildings, in vehicle manufacture, ship building, and in equipment and machine manufacture. Preferably, the composite panels are used as facade panels, cladding on building constructions, or dividing walls in buildings, vehicles and ship structures. In one example, the composite panels are used as facade panels or cladding on building constructions.

The disclosure also provides a method of forming the cladding composition defined herein. The cladding composition can for example be manufactured by mixing the various components e.g. dry mixing in a mixer for solids e.g. a force-mixer, screw-type mixer, tumble mixer or fluid mixer or other mixer operating in a continuous or discontinuous manner. In some embodiments, the method comprises combining the silicate mineral and inorganic phosphate (and optionally the borate, heat expandable solid material and one or more of the additives) to form a ceram mixture, combining the ceram mixture with the inorganic binder and adding water to form a slurry. While water is used in the exemplified method, any suitable solvent can be used. Sufficient water is added to form a slurry that can be, for example, poured, sprayed and/or moulded. In some embodiments, the slurry comprises between 10% to 50% water, between 20% to 40% water, or between 25% to 35% water by weight based on the total weight of the slurry composition. In some embodiments, the slurry comprises about 30% water by weight based on the total weight of the slurry composition. In some embodiments, the resulting slurry is dried at 70° C. to consistent weight. The slurry may be formed in a suitable mould to form the desired shape or continuous profile of the articles defined herein. The cladding composition described herein may, for example, be in the form of a block, rod, strip, sheet, panel or other shaped article.

In some embodiments, the composition is in the form of a slurry comprising a solvent. In some embodiments, the solvent is water. In some embodiments, the composition is a dried composition.

When manufacturing composite panels with two outer layers and a core, wherein the core comprises or consists of the cladding composition defined herein, the cladding composition can be prepared by mixing the individual components as described herein. The composite panels can be manufactured using processes known in the art.

The composite panel, as described herein, offers one or more advantages when compared to composite panels (e.g. ACP) known in the art. In at least some embodiments, the composite panels defined herein are characterised by way of their extremely high resistance to heat and combustion. In at least some embodiments, the composite panels meet the appropriate standards for use in the building industry classification requirements e.g. AS1530.1. In at least some embodiments, the composite panels are lightweight.

Furthermore, the combination of ceram mixture and gypsum or plaster of Paris provides one or more additional advantages. When gypsum based panels are exposed to fire, heat is absorbed as a portion of the combined water is driven off as steam. This process keeps the opposite side of the gypsum panel cool as long as there is crystalline water left to be converted into steam or until the gypsum based panel is breached. In the case of regular gypsum board, as the crystalline water is driven off, the reduction of volume within the gypsum core causes large cracks to form, eventually causing the panel to fail due to loss of structural integrity. Without wishing to be bound by theory, it is thought that ceramification of the components of the ceram mixture binds together the components of the cladding composition and helps compensate for the loss of water maintaining structural integrity.

It will be appreciated by persons skilled in the art that numerous variations and/or modifications may be made to the above-described embodiments, without departing from the broader general scope of the present disclosure. The present embodiments are, therefore, to be considered in all respects as illustrative and not restrictive.

The disclosure will now be described with reference to the following examples. It is to be understood that the examples are provided by way of illustration of the disclosure and that they are in no way limiting to the scope of the disclosure.

### EXAMPLES

### Method of Preparation

Example materials were made by combining the silicate mineral, inorganic phosphate and optionally the borate and heat expandable solid to form the ceram mixture. The ceram mixture was then combined with the inorganic binder and water was added to form a slurry. The slurry was applied to a surface and dried at 70° C. until a constant weight was reached.

### Fire-Resistance Testing

Fire-resistance testing can be performed by testing facilities approved by the National Association of Testing Authorities such as AS1530.

### Example 1

The cladding composition of example 1 was prepared as described above and with the composition shown in Table 1, which was found to meet AS1530.1 test.

TABLE 1

| Component | Amount | |
|---|---|---|
| Wollastonite | 58.5 | g |
| Ammonium polyphosphate | 29 | g |
| Zinc borate | 6 | |
| Grafguard (expandable graphite) | 6.5 | |
| Total ceram mixture | 100 | g |
| Plaster of Paris | 40 | g |
| Water | 60 | g |
| | 200 | g |

1: A cladding composition comprising:
an inorganic binder;
a silicate mineral; and an
inorganic phosphate.

2: The composition of claim 1, wherein the composition forms a ceramic on exposure to an elevated temperature experienced under fire conditions.

3: The composition of claim 1, wherein the composition is substantially free of organic polymer.

4: The composition of claim 1, further comprising a borate.

5: The composition of claim 4, wherein the borate is zinc borate.

6: The composition of claim 4, wherein the borate is present in an amount of 0.1% to 10% by weight of the total composition.

7: The composition of claim 1, wherein the inorganic phosphate is selected from the group consisting of ammonium phosphate, ammonium polyphosphate or ammonium pyrophosphate and combinations thereof.

8: The composition of claim 7, wherein the inorganic phosphate is ammonium polyphosphate.

9: The composition of claim 1, wherein the inorganic phosphate is present in an amount of 10% to 40% by weight of the total composition.

10: The composition of claim 1, wherein the silicate mineral is selected from the group consisting of an alumina-silicate, an alkali alumina-silicate, a magnesium silicate or a calcium silicate and combinations thereof.

11: The composition of claim 1, wherein the silicate mineral is wollastonite.

12: The composition of claim 1, wherein the silicate mineral is present in an amount of 20% to 60% by weight of the total composition.

13: The composition of claim 1, wherein the inorganic binder is selected from the group consisting of cement, gypsum, plaster of Paris and combinations thereof.

14: The composition of claim 1, wherein the inorganic binder is gypsum (CaSQ₄.2H₂O) or plaster of Paris (CaSQ₄.0.5H₂O).

15. (canceled)

16: The composition of claim 1, wherein the inorganic binder is present in an amount of 10% to 60% by weight of the total composition.

17: The composition of claim 1, further comprising a heat expandable solid material selected from the group consisting of beneficiated flakes of vermiculite, unexpanded perlite, hydrobiotite, unexpanded foam clay, expandable graphite, water-swelling synthetic tetrasilicic fluorine type mica and combinations thereof.

18-19. (canceled)

20: The composition of claim 17, wherein the heat expandable solid material is present in an amount of 0.1% to 10% by weight of the total composition.

21. (canceled)

22: The composition of claim 1, wherein the composition has a fire resistance based on AS 1530 part 1.

23: A fire-performance article comprising the composition of claim 1.

24-25. (canceled)

26: A composite panel comprising two outer layers and a core, wherein the core comprises the composition of claim 1.
